(19) United States
(12) Patent Application Publication
(10) Pub. No.: US 2015/0186689 A1
(43) Pub. Date: Jul. 2, 2015

(54) RFID Tag and Method for Protecting an RFID Tag

(71) Applicant: SIEMENS AKTIENGESELLSCHAFT, München, Deutschland (DE)

(72) Inventors: Erwin Hess, Ottobrunn (DE); Hermann Seuschek, Munchen (DE)

(21) Appl. No.: 14/404,547

(22) PCT Filed: Mar. 27, 2013
(86) PCT No.: PCT/EP2013/056485

§ 371 Date: Nov. 28, 2014

(30) Foreign Application Priority Data
May 31, 2012 (DE) 10 2012 209 148.3

(51) Int. Cl. G06K 7/10; G06K 19/073

(52) U.S. Cl. CPC G06K 7/10267; G06K 19/073

(57) ABSTRACT

An RFID tag for a product includes an RFID chip configured for processing data, an antenna configured for transmitting the data, and a security part. The security part is configured to destroy the RFID chip in case of a predetermined use of the product. Therefore, the RFID tag is reliably protected against illegal further use. A product having such an RFID tag and a method for safeguarding an RFID tag against inadmissible use of the RFID tag are described.

### RELATED APPLICATIONS

This application is the National Stage of International Application No. PCT/EP2013/056485, filed Mar. 27, 2013, which claims the benefit of German Patent Application No. DE 102012209148.3, filed May 31, 2012. The entire contents of both documents are hereby incorporated herein by reference.

### TECHNICAL FIELD

The present teachings relate generally to RFID tags and to methods for protecting RFID tags against inadmissible use.

### BACKGROUND

Radio frequency identification (RFID) is a technology that may be used to assign an explicit identification number (ID) to products or physical objects (e.g., identification documents, components, spare parts, containers, packages or transport containers), and to read the explicit identification number using radio technology (RF). Furthermore, in the case of specially equipped RFID tags or RFID labels that allow a cryptographical authenticity check, the counterfeit protection for products and spare parts may be increased.

In some applications, the RFID tag may be deactivated following use to protect privacy or to prevent misuse of the RFID tag.

When RFID tags are used as protection against counterfeiting, the RFID tag—after a predetermined, admissible use and after the authenticity of the product protected thereby has been recognized—may be removed from the product and affixed to an illegal copy. For example, if the product to be protected is the contents of a container (e.g., a pharmaceutical or a perfume), the container may be refilled with a counterfeit product and put back into circulation.

Conventional solutions are directed at protecting user privacy. For example, the antenna of the RFID tag may be destroyed mechanically (e.g., the RFID tag may be torn to pieces in order to break its conductor tracks for the antenna), such that a user may observe the deactivation of the RFID tag. However, since conductor tracks are relatively coarse structures, the conductor tracks may be repaired with relative ease.

RFID tags may also be deactivated using a command integrated into the RFID tag. For example, the EPCGlobal RFID standard, referred to as a kill command, may be used. However, an RFID reader may be needed in order to send the kill command.

### SUMMARY AND DESCRIPTION

The scope of the present invention is defined solely by the appended claims, and is not affected to any degree by the statements within this summary.

The present embodiments may obviate one or more of the drawbacks or limitations in the related art. For example, in some embodiments, an RFID tag is provided that—following a predetermined use—is protected against illegal further use.

An RFID tag for a product includes an RFID chip configured for processing data, an antenna configured for transmitting the data, and a security part. The security part is configured to destroy the RFID chip in an event of a predetermined use of the product.

The RFID tag may be destroyed following a first predetermined use of the product and may therefore be referred to as a self-destructing RFID tag. Since the RFID tag is destroyed irreversibly following the first predetermined use, the RFID tag is protected against illegal further use. The predetermined use of the product may include the use thereof as intended. In addition, by way of example, the predetermined use may include opening of the product or an attempt to remove the RFID tag from the product. The RFID chip may be destroyed (e.g., in some embodiments, irreversibly). Destroyed semiconductor structures of the RFID chip may not be reparable. Hence, misuse of an RFID tag that has already been used in a predetermined manner may be avoided. When the RFID tag has been successfully removed from the product and affixed to an illegal copy, the RFID tag is no longer able to simulate the supposed authenticity of the illegal copy. Thus, the RFID tag is destroyed following its intended use and, therefore, becomes worthless to a counterfeiter.

As used herein, an RFID tag is a device that is configured for radio frequency identification (RFID). The RFID tag may be configured for identification by electromagnetic waves. The RFID tag may also be referred to as an RFID label, RFID apparatus, or RFID transponder.

In some embodiments, the security part is configured to generate an electrical signal in the event of the predetermined use of the product, and to destroy the RFID chip by the generated electrical signal.

The destruction of the RFID tag by an electrical signal provides a technically simple and inexpensive way of destroying the semiconductor structures of the RFID tag.

In some embodiments, the electrical signal is a voltage pulse or a current pulse.

In some embodiments, the security part includes a piezoelectric transducer that is coupled to the RFID chip, the piezoelectric transducer being configured to convert a mechanical force employed in the event of the predetermined use of the product into a voltage signal, and to couple the voltage signal into the RFID chip such that the RFID chip is destroyed.

In some embodiments, the RFID chip is destroyed by an electrical voltage pulse produced by the piezoelectric transducer. Piezoelectric transducers include a piezoelectric material that produces an electrical voltage in response to a mechanical force. By way of example, the action of force may involve removal by bending the RFID tag. For example, if the product is a container with a screw closure (e.g., a bottle), the forces involved in the process of opening of the screw closure may be used to produce an electrical voltage pulse.

The use of a piezoelectric transducer to produce a voltage signal for destroying the RFID chip provides an inexpensive and simple solution. In addition, piezoelectric transducers may be easily integrated into RFID tags due to the size of the piezoelectric transducers.

In some embodiments, the security part includes a triboelectric transducer that is coupled to the RFID chip, the triboelectric transducer being configured to convert a friction occurring in the event of the predetermined use of the product into a voltage signal, and to couple the voltage signal into the RFID chip such that the RFID chip is destroyed.

The triboelectric transducer may be used as an alternative to a piezoelectric transducer, such as in applications wherein the product is torn open. The action of tearing provides the friction used to produce the voltage signal.

In some embodiments, the triboelectric transducer includes an electrostatic film that is configured to generate the voltage signal in the event of the predetermined use of the product by friction arising from tearing open the electrostatic film.

The electrostatic film may be used as the triboelectric transducer in applications involving a shallow design. In addition, the electrostatic film may be used in applications wherein the product is torn open in the event of the predetermined use.

In some embodiments, the security part is configured to destroy the RFID chip mechanically in the event of the predetermined use of the product.

The mechanical irreversible destruction of the RFID chip may be used as an inexpensive alternative to destruction by an electrical signal.

In some embodiments, the security part includes an energy transducer that is coupled to the RFID chip, the energy transducer being configured to convert a first mechanical energy employed in the event of the predetermined use of the product into a second mechanical energy to destroy the RFID chip.

Energy transducers may be used in a variety of applications. By way of example, the energy transducer may be in the form of a pin that is pushed into the RFID chip in the event of a bottle closure being opened, thereby mechanically destroying irreversibly the RFID chip.

In some embodiments, the security part is configured to destroy the RFID chip thermally in the event of the predetermined use of the product.

The thermal destruction of the RFID chip may be used as an alternative to electrical and mechanical destruction.

In some embodiments, the RFID tag includes an airtight container configured for holding the RFID chip, the RFID chip including at least one oxidation-sensitive metal layer. The security part may be configured to open the container in the event of the predetermined use of the product, such that the oxidation-sensitive metal layer destroys the RFID chip by oxidation.

The oxidation-sensitive metal layer may be readily integrated into an RFID tag in a space-saving manner. The security part may be in the form of a single pin that is pushed into the container in the event of the product (e.g., a bottle closure) being opened, thereby allowing air to penetrate the container.

In some embodiments, the RFID tag is in the form of a passive RFID tag.

In some embodiments, a product includes an RFID tag of a type described above. By way of example, the product may be a container or a package having the RFID tag affixed thereto.

A method for protecting an RFID tag for a product against inadmissible use of the RFID tag, the RFID tag including an RFID chip configured for processing data and an antenna configured for transmitting the data, includes destroying the RFID chip in the event of the predetermined use of the product.

### BRIEF DESCRIPTION OF THE DRAWINGS

FIG. 1 shows a schematic block diagram of a first example of a self-destructing RFID tag.

FIG. 2 shows a schematic block diagram of a second example of a self-destructing RFID tag.

FIG. 3 shows a flowchart of an exemplary method for protecting an RFID tag against inadmissible use.

### DETAILED DESCRIPTION

In the figures, elements that are the same or that have the same function have been provided with the same reference symbols unless stated otherwise.

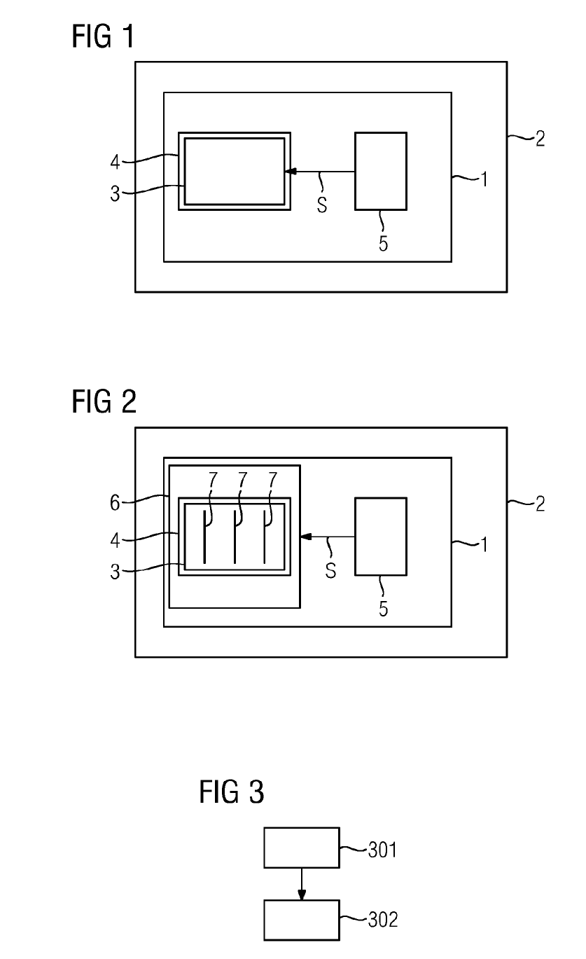

FIG. 1 shows a schematic block diagram of an example of a self-destructing RFID tag 1 for a product 2 (e.g., a package or a container). By way of example, the RFID tag 1 is a passive RFID tag 1 and the product 2 is a container or a package.

The RFID tag 1 has an RFID chip 3 for processing data, and an antenna 4 for transmitting the data (e.g., to an RFID receiver). In addition, the RFID tag 1 has a security part 5 that is configured to destroy the RFID chip 3 in the event of a predetermined use of the product 2.

By way of example, the security part 5 is configured to generate an electrical signal S in the event of the predetermined use of the product 2, and to destroy the RFID chip 3 by the generated electrical signal S.

The electrical signal S may be a voltage pulse or a current pulse.

In addition, the security part 5 may include a piezoelectric transducer that is coupled to the RFID chip 3. The piezoelectric transducer 5 is configured to convert a mechanical force employed in the event of the predetermined use of the product 2 into a voltage signal S, and to couple the voltage signal S into the RFID chip 3 such that the RFID chip 3 is destroyed.

Alternatively or in addition, the security part 5 may include a triboelectric transducer. The triboelectric transducer is coupled to the RFID chip 3. The triboelectric transducer 5 is configured to convert friction occurring in the event of the predetermined use of the product 2 into a voltage signal S, and to couple the voltage signal S into the RFID chip 3 such that the RFID chip 3 is destroyed.

By way of example, the triboelectric transducer 5 may include an electrostatic film that is configured to generate the voltage signal S in the event of the predetermined use of the product 2 by friction arising from tearing open the electrostatic film 5.

The security part 5 may be configured to destroy the RFID chip 3 mechanically in the event of predetermined use of the product 2.

Alternatively or in addition, the security part 5 may include an energy transducer that is coupled to the RFID chip 3. The energy transducer 5 is configured to convert a first mechanical energy employed in the event of the predetermined use of the product 2 into a second mechanical energy to destroy the RFID chip 3.

The security part 5 may be configured to destroy the RFID chip 3 thermally (e.g., by thermal energy) in the event of predetermined use of the product.

FIG. 2 shows a block diagram of a second example of a self-destructing RFID tag 1. The RFID tag 1 in FIG. 2 has an airtight container 6 configured for holding at least the RFID chip 3. Alternatively, the airtight container 6 may be configured to hold the entire RFID tag 1. The RFID chip 3 in FIG. 2 has at least one oxidation-sensitive electrical conductor (e.g., an oxidation-sensitive metal layer 7) that allows operation of the RFID tag 1 when the oxidation-sensitive electrical conductor is undamaged. In other words, a damaged (e.g., an oxidized metal layer 7) destroys the RFID chip 3.

The security part 5 is configured to open the container 6 in the event of predetermined use of the product 2, such that the oxidation-sensitive metal layer 7 destroys the RFID chip 3 via oxidation (e.g., coming into contact with oxygen that enters the container 6). In other words, when the product 2 is used as intended, the intended use triggers the security part 5 to open the container 6, thereby allowing oxygen to penetrate. The penetrating oxygen results in oxidation of the oxidation-sensitive metal layer 7. The oxidized metal layer 7 is therefore damaged, and the damaged metal layer 7 results in the destruction of the RFID chip 3.

FIG. 3 shows a flowchart of an exemplary method for protecting an RFID tag 1 for a product 2 against inadmissible use of the RFID tag 1.

In act 301, the RFID tag 1 is equipped with a security part 5.

In act 302, the security part 5 is prompted to destroy the RFID chip in the event of predetermined use of the product 2.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding claim—whether independent or dependent—and that such new combinations are to be understood as forming a part of the present specification.

1. An RFID tag for a product the RFID tag comprising:
an RFID chip configured for processing data;
an antenna configured for transmitting the data; and
a security part configured to destroy the RFID chip in an event of a predetermined use of the product.

2. The RFID tag of claim 1, wherein the security part is configured to generate an electrical signal in the event of the predetermined use of the product, and to destroy the RFID chip by the generated electrical signal.

3. The RFID tag of claim 2, wherein the electrical signal comprises a voltage pulse or a current pulse.

4. The RFID tag of claim 1, wherein the security part comprises a piezoelectric transducer that is coupled to the RFID chip, the piezoelectric transducer being configured to convert a mechanical force employed in the event of the predetermined use of the product into a voltage signal, and to couple the voltage signal into the RFID chip to destroy the RFID chip.

5. The RFID tag of claim 1, wherein the security part comprises a triboelectric transducer that is coupled to the RFID chip, the triboelectric transducer being configured to convert friction occurring in the event of the predetermined use of the product into a voltage signal, and to couple the voltage signal into the RFID chip to destroy the RFID chip.

6. The RFID tag of claim 5, wherein the triboelectric transducer comprises an electrostatic film that is configured to generate the voltage signal in the event of the predetermined use of the product by friction arising from opening of the electrostatic film.

7. The RFID tag of claim 1, wherein the security part is configured to destroy the RFID chip mechanically in the event of the predetermined use of the product.

8. The RFID tag of claim 7, wherein the security part comprises an energy transducer that is coupled to the RFID chip, the energy transducer being configured to convert a first mechanical energy employed in the event of the predetermined use of the product into a second mechanical energy to destroy the RFID chip.

9. The RFID tag of claim 1, wherein the security part is configured to destroy the RFID chip thermally in the event of the predetermined use of the product.

10. The RFID tag of claim 1, further comprising an air-tight container configured for holding the RFID chip, wherein the RFID chip comprises at least one oxidation-sensitive metal layer, wherein the security part is configured to open the container in the event of the predetermined use of the product (2), and wherein the oxidation-sensitive metal layer is configured to destroy the RFID chip via oxidation.

11. The RFID tag of claim 1, wherein the RFID tag is in a form of a passive RFID tag.

12. A product comprising an RFID tag, the RFID tag comprising:
an RFID chip configured for processing data;
an antenna configured for transmitting the data; and
a security part configured to destroy the RFID chip in an event of a predetermined use of the product.

13. The product of claim 12, wherein the product is a container or package.

14. A method for protecting an RFID tag for a product against inadmissible use of the RFID tag, the RFID tag comprising an RFID chip configured for processing data and an antenna configured for transmitting the data, the method comprising destroying the RFID chip in an event of a predetermined use of the product.

15. The RFID tag of claim 2, wherein the security part comprises a piezoelectric transducer that is coupled to the RFID chip, the piezoelectric transducer being configured to convert a mechanical force employed in the event of the predetermined use of the product into a voltage signal, and to couple the voltage signal into the RFID chip to destroy the RFID chip.

16. The RFID tag of claim 3, wherein the security part comprises a piezoelectric transducer that is coupled to the RFID chip, the piezoelectric transducer being configured to convert a mechanical force employed in the event of the predetermined use of the product into a voltage signal, and to couple the voltage signal into the RFID chip to destroy the RFID chip.

17. The RFID tag of claim 2, wherein the security part comprises a triboelectric transducer that is coupled to the RFID chip, the triboelectric transducer being configured to convert friction occurring in the event of the predetermined use of the product into a voltage signal, and to couple the voltage signal into the RFID chip to destroy the RFID chip.

18. The RFID tag of claim 3, wherein the security part comprises a triboelectric transducer that is coupled to the RFID chip, the triboelectric transducer being configured to convert friction occurring in the event of the predetermined use of the product into a voltage signal, and to couple the voltage signal into the RFID chip to destroy the RFID chip.

19. The RFID tag of claim 17, wherein the triboelectric transducer comprises an electrostatic film that is configured to generate the voltage signal in the event of the predetermined use of the product by friction arising from opening of the electrostatic film.

20. The RFID tag of claim 18, wherein the triboelectric transducer comprises an electrostatic film that is configured to generate the voltage signal in the event of the predetermined use of the product by friction arising from opening of the electrostatic film.
